(19) United States
(12) Patent Application Publication
(10) Pub. No.: US 2012/0004832 A1
(43) Pub. Date: Jan. 5, 2012

(54) METHOD AND DEVICE FOR OPERATING A DRIVE UNIT

(76) Inventors: Jens-Werner Falkenstein, Aalen (DE); Markus Vogelgesang, Benningen am Neckar (DE); Martin Lang, Hausleiten (AT)

(21) Appl. No.: 12/998,332

(22) PCT Filed: Sep. 29, 2009
(86) PCT No.: PCT/EP2009/062590

§ 371 Date: Sep. 21, 2011

(30) Foreign Application Priority Data
Oct. 13, 2008 (DE) 10 2008 042 783.7

(51) Int. Cl. F02D 41/04

(52) U.S. Cl. 701/104; 701/101

(57) ABSTRACT

A method for operating an internal combustion engine includes: providing a desired power specification for triggering the drive unit; providing a specification of operating point-dependent power ranges for the supplied desired power specification, in which steady-state operation of the drive unit is permissible, a power range that is not permissible in the steady state being defined between the operating point-dependent power ranges; when a change in the desired power specification for the drive unit in a transitional operating mode necessitates traversing the power range that is not permissible in the steady state, triggering the drive unit on the basis of a specification of a guided desired power, the guided desired power specification being determined by guiding the desired power specification.

### BACKGROUND OF THE INVENTION

1. Field of the Invention

The present invention relates to the operation of drive units having an operating range that is not permissible in the steady state, in particular internal combustion engines and operation thereof, operating modes using injection blank-outs being usable in particular.

2. Description of Related Art

Modern internal combustion engines have an air supply system to control the air mass flow, which is supplied to the cylinders of the internal combustion engine. A throttle valve which regulates the air flow into the intake manifold is in most cases situated in the air supply system. In modern internal combustion engines, the throttle valve is adjusted electrically. The final rate of adjustment of the throttle valve as well as dynamic filling effects in the intake manifold do not allow a highly dynamic adjustment of a specified air mass flow. Therefore, rapid adjustments of the torque supplied by the internal combustion engine cannot be made using this adjustment mechanism.

Therefore, during operation of the internal combustion engine, a lead desired torque is provided, which may provide an increased air filling in the cylinders in the static operating range, so that an increased torque may be retrieved rapidly by adjusting the ignition angle. Therefore, an intervention in the ignition angle may be utilized to achieve a rapid change in torque of the internal combustion engine.

A reduction in the torque of the engine based on a lower desired torque specification is achieved with the help of a retard adjustment of the ignition angle with respect to a basic ignition angle, causing a reduced efficiency of the internal combustion engine, which then has a negative effect on fuel consumption. The actual torque of the internal combustion engine is thereby lowered in comparison with the basic torque and follows the specified desired torque (which is declining). A reduction in torque via a retard adjustment of the ignition angle is possible up to the minimum basic torque, which is defined by the combustibility limit as well as by component safety limits and depends on the prevailing basic torque (i.e., the prevailing filling), among other things.

A further reduction in torque with a corresponding low desired torque is then achievable only through an injection blank-out of individual cylinders. However, injection blank-outs are associated with higher exhaust gas emissions, increased uneven running of the internal combustion engine and noise problems. Injection blank-out operation is technically possible in a steady state but should only be done temporarily. Quasi-steady-state operation, including injection blank-out of individual cylinders, should therefore be avoided.

The actual torque of the internal combustion engine may be reduced by injection blank-out of all cylinders down to the minimal torque corresponding to the loss torque of the internal combustion engine. This is a case of overrun fuel cutoff, in which the disadvantages of operating with an injection blank-out of only some of the cylinders no longer exist. The overrun fuel cutoff is therefore adjustable over a longer period of time and thus in a quasi-steady state. This yields torque ranges for the desired torque which may be utilized during normal operation in a quasi-steady state:
a first torque range, which corresponds to the torque range between the basic torque and the minimal basic torque, depending on the prevailing filling; and
a second torque range, which is defined by the overrun fuel cutoff of the internal combustion engine and corresponds to a minimal engine torque representing the loss torque of the internal combustion engine.

In between there is a torque range for the desired torque which should not be utilized, i.e., is not permitted, in a quasi-steady state during normal operation because of the disadvantages described above with respect to uneven running and exhaust gas emissions. However, depending on the desired torque requested, this may result in a rapid change between the first and second torque ranges to supply a torque which is in the torque range between the first and second torque ranges. Such a rapid change results in torque jumps, which may become noticeable as uncomfortable jerking during driving operation.

Under certain circumstances, the torque range permitted and usable during normal operation is additionally restricted, for example, when only injection operation of all cylinders is permitted for emission reasons because the temperature of the catalytic converter is too low and an injection blank-out of individual cylinders or an overrun fuel cutoff is not permitted.

In addition, it is possible that operation departs from normal operation during safety-critical interventions or safety interventions, for example, ESP, emergency running, maximum rpm downregulation, monitoring, component protection, speed limit, and the like, and the torque ranges that are not permissible in the steady state during normal operation may also be adjusted for a longer period of time. In addition, interventions of an automatic transmission into the desired torque, for example, during shifting operations, among other things, may necessitate a deviation from normal operation.

The object of the present invention is to make available a method for operating an internal combustion engine in which there is a provision for permitting only temporarily a torque range which is not usable or is not permissible in a steady state during normal operation, for example, the torque range, which may be achieved only through a cylinder blank-out of individual cylinders, so that during transitions between desired torques occurring in various torque ranges which are permitted in a steady state, there should not be any uncomfortable jumps in the torque supplied by the internal combustion engine during operation of a vehicle.

### BRIEF SUMMARY OF THE INVENTION

According to a first aspect of the present invention, a method is provided for operating an internal combustion engine, which method includes the following steps:
providing a specification variable for triggering the drive unit to supply an output variable;
providing a specification of operating point-dependent output variable ranges for the specification variable supplied, in which steady-state operation of the drive unit is permissible, an output variable range that is not permissible in the steady state being defined between the operating point-dependent output variable ranges;
if, during a transitional operating mode, a change in the specification variable for the drive unit necessitates traversing of the output variable range that is not permissible in the steady state, triggering the drive unit on the basis of a guided specification variable,
   the guided specification variable being determined by guiding the specification variable, so that the period of time during which the drive unit is triggered to supply the guided specification variable within the output variable range that is not permissible in the steady state is limited to a specified maximum period of time.

One idea of the above method is to limit the period of time during which the drive unit is triggered to supply an output variable in an output variable range that is not permissible in the steady state in that the specification variable is guided during a transitional operating mode between the output variable ranges that are permissible in the steady state.

It is possible in particular to provide that the specification variable is guided by limiting the specification variable with respect to one or more limiting values to obtain the guided specification variable, so that the limiting value(s) is (are) obtained from one or more specified limiting value curves within a first of the output variable ranges and a second of the output variable ranges.

One idea of the above method is to ascertain instantaneous limiting values, which are valid for the prevailing operating point and are determined for a specified specification variable, and to ascertain the output variable ranges in which continuous operation of the drive unit is permitted. The instantaneous limiting values are adjusted dynamically in such a way that they only temporarily permit a specification variable, which is within an output variable range that is not permissible in the steady state, for example, to achieve comfortable transitions between the output variable ranges that are permissible in the steady state. For this purpose, the instantaneous limiting values are further adapted dynamically in such a way that no additional jumps (i.e., apart from jumps caused by other factors, for example, the driver's desired torque) in the guided (limited) specification variable are thereby created.

In the above method, a specification variable in particular which is within the output variable ranges that are permissible in the steady state, may be permitted, i.e., not limited. An immediate response to a change in the driver's desired torque within the output variable range that is permissible in the steady state is thus possible, for example. In addition, rapid traversing of an output variable range that is not permissible in the steady state at a corresponding curve of the specification variable is also permitted. However, traversing the output variable range too slowly is not permitted, as it may cause elevated exhaust gas emissions, increased uneven running of the internal combustion engine and/or emission of too much noise.

In hybrid vehicles in particular, rapidly traversing the output variable range that is not permissible in the steady state, is enabled when a compensation of a rapidly changing specification variable is possible by one or more electric motors or hydraulic motors. Rapid changes in the total drive power, for example, may thus be prevented, thereby ensuring good driving comfort.

In addition, the specification variable may be guided by limiting the specification variable with respect to one or more limiting values to obtain the guided specification variable, the limiting value(s) being obtained from one or more specified limiting value curves between a first of the output variable ranges and a second of the output variable ranges.

In addition, the specification variable may be limited to the first or second output variable range if there is no transitional operating mode.

According to one specific embodiment, the first and the second output variable ranges may each be defined by a lower output variable range limit and an upper output variable range limit, the upper output variable range limit of the second output variable range being lower than the lower output variable range limit of the first output variable range, the limiting value curve being defined as monotonic and steady between the upper output variable range limit of the second output variable range and the lower output variable range limit of the first output variable range within the specified maximum period of time.

According to one specific embodiment, the specification variable of a desired torque specification and/or the output variable range may correspond to torque ranges.

According to one specific embodiment, the first torque range may be defined as the torque range between a minimal basic torque, which indicates the minimal drive torque, suppliable by intervention into the ignition angle at the existing air filling in the cylinders and an optimal basic torque, which indicates the maximal drive torque suppliable by intervention into the ignition angle at the existing air filling in the cylinders and/or the second torque range may represent a minimal torque, which is determined by the torque supplied by the internal combustion engine at the instantaneous operating point during the overrun fuel cutoff.

Alternatively or additionally, the torque ranges (in particular the first torque range) may be spanned by varying the injected fuel quantity and/or by varying the start of injection and/or by varying the injection pattern and/or by varying the exhaust gas recirculation rate and/or by varying the exhaust gas back-pressure, etc.

In particular when the transitional operating mode is occurring with a change in the operating point of the internal combustion engine from the first torque range to the second torque range, the desired torque may be limited to an upper limiting value specified by a first limiting value curve if the desired torque is within the torque range that is not permissible in the steady state.

In particular when the transitional operating mode is occurring with a change in the operating point of the internal combustion engine from the second torque range to the first torque range, the desired torque may be limited to a lower limiting value specified by a second limiting value curve if the desired torque is within the torque range that is not permissible in the steady state.

In particular when the transitional operating mode is occurring with a change in the operating point of the internal combustion engine from the second torque range to the first torque range, the desired torque may be limited to an upper limiting value specified by a third limiting value curve if the desired torque is within the torque range that is not permissible in the steady state.

In particular when the transitional operating mode is occurring with a change in the operating point of the internal combustion engine from the first torque range to the second torque range, the desired torque may be limited to a lower limiting value specified by a fourth limiting value curve if the desired torque is within the torque range that is not permissible in the steady state.

According to one specific embodiment, the desired torque may be limited with respect to one or more limiting values as a function of an operating mode signal indicating whether normal operation or an exceptional operation prevails.

In the exceptional operating mode in particular, it may be permissible to use a torque range that is not permissible in the steady state for a longer period of time and/or not to take into account additional restrictions if, for example, safety-critical interventions or safety interventions (for example, ESP, emergency running, maximal rpm downregulation, monitoring, component protection, speed limit, and the like) or interventions of an automatic transmission have a higher priority.

In addition, in a motor system in which an internal combustion engine is operated as a function of a desired torque formed from a driver's desired torque and a torque intervention supplied by a requester, the torque range limits defining the torque ranges that are permissible in the steady state are transmitted to the requester. The requester may thus select optimal operating points for the internal combustion engine and the electric motor and thus optimize a driving strategy, for example, in the case of hybrid vehicles having a degree of freedom in the choice of operating point. If the engine control device and the requester are implemented in different units, communication of the instantaneous torque range limits from the internal combustion engine to the requester may be implemented easily via a bus system, because the dynamics of changes in torque range limits at the prevailing operating point are lower than the dynamics of the internal combustion engine and the requester, so that signal delays in communication are not critical.

In addition, it is possible to provide for the torque range that is not permissible in the steady state as well as a torque range in which an overrun fuel cutoff operation occurs, for example, not to be permitted at least temporarily in an operating mode because the catalytic converter temperature is too low, for example. For this purpose, a corresponding blocking signal may be generated, which requests a change from one torque range that is permissible in the steady state during normal operation to another torque range that is permissible in the steady state during normal operation, but does not permit, i.e., prevents this change based on the additional restrictions given above.

In addition, the transitional operating mode may be determined as a function of an intervention signal, the intervention signal indicating the change in operating point of the internal combustion engine which requires traversing the torque range that is not permissible in the steady state.

According to one specific embodiment, the specification variable may be guided according to a specified time curve. In particular the specified time curve may be such that the guided specification variable reaches the subsequent operating range that is permissible in the steady state when the specified maximum period of time has elapsed.

According to another aspect, a device for operating an internal combustion engine is provided. The device includes:
a requester for supplying a specification variable for triggering the drive unit to supply an output variable;
a specification variable guidance unit for guiding the specification variable;
an engine control unit to operate the drive unit so that an output variable of the drive unit is supplied according to the guided specification variable;
a guidance unit which is designed
   to provide a specification about operating point-dependent output variable ranges for the supplied specification variable, in which a steady-state operation of the drive unit is permissible, an output variable range that is not permissible in the steady state being defined between the operating point-dependent output variable ranges; and
   to trigger the drive unit on the basis of the guided specification variable when in a transitional operating mode a change in the specification variable for the drive unit necessitates traversing the output variable range that is not permissible in the steady state,
      the guided specification variable being determined by guiding the specification variable so that the period of time during which the drive unit is triggered to supply the guided specification variable within the output variable range that is not permissible in the steady state is limited to a specified maximum period of time.

The requester may correspond in particular to a torque requester, the guidance unit may correspond to a limiting unit and the specification variable guidance unit may correspond to a desired torque limiter.

According to another aspect, a motor system is provided having the above device and an engine control unit, which triggers a drive unit as a function of the guided specification variable.

According to another aspect, a computer program is provided which executes the above method when it is executed on a data processing unit.

### BRIEF DESCRIPTION OF THE DRAWINGS

FIG. 1 shows a schematic block diagram of an engine system for implementing a method for avoiding torque ranges that are not permissible in the steady state.

FIG. 2 shows a signal-time diagram, which indicates the curves of the limiting values for limitation of the desired torque, the limited desired torque and a torque request signal and an operating mode signal.

### DETAILED DESCRIPTION OF THE INVENTION

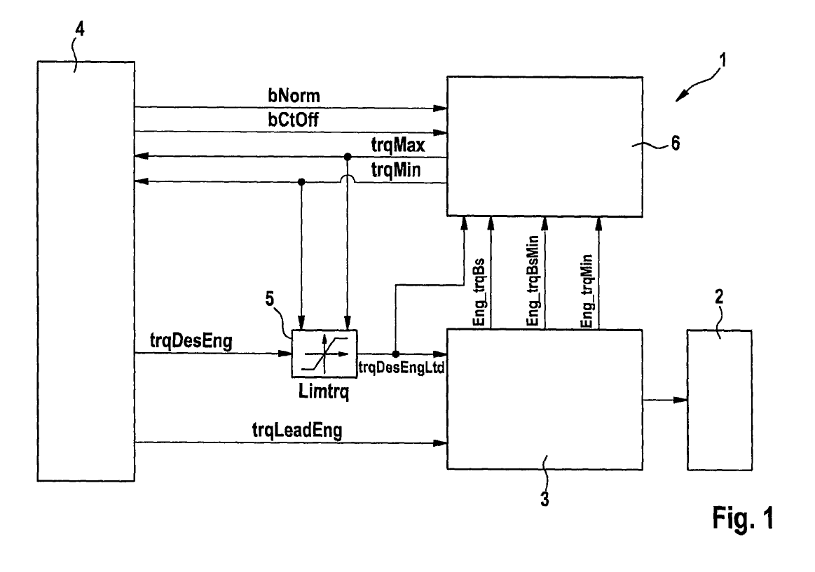

FIG. 1 shows a schematic diagram of an engine system 1 having an internal combustion engine 2. Internal combustion engine 2 is triggered via an engine control unit 3 with the help of engine control signals which specify, for example, a position of the throttle valve, a fuel injection quantity to be injected into a cylinder before each combustion process, ignition times for igniting an air/fuel mixture in the cylinder, and the like. To generate the engine control signals, engine control unit 3 receives a lead desired torque trqLeadEng from a torque requester 4. In addition, torque requester 4 supplies a desired torque, which indicates unlimited desired torque trqDesEng to be supplied by internal combustion engine 2.

Unlimited desired torque trqDesEng is supplied to a desired torque limiter 5, which forwards a limited desired torque trqDesEngLtd to engine control unit 3. Limiting unit 5 receives as additional input variables information about an upper instantaneous limiting value trqMax and a lower instantaneous limiting value trqMin, defining the range to which the instantaneous unlimited desired torque is to be limited.

Engine control unit 3 ascertains basic torque Eng_trqBs as well as minimal basic torque Eng_trqBsMin, which respond with a delay when there is a change in the desired torque to lead desired torque trqLeadEng, based on the air path dynamics.

In addition, engine control unit 3 determines a minimal torque Eng_trqMin, which depends on the instantaneous rpm, the internal combustion engine temperature and additional parameters and corresponds to a loss torque of the internal combustion engine, which occurs when no drive torque is being generated by internal combustion engine 2. In other words, minimal torque Eng_trqMin represents the torque of internal combustion engine 2 during overrun fuel cutoff operation.

Basic torque Eng_trqBs, minimal basic torque Eng_trqBsMin and minimal torque Eng_trqMin are supplied to a limiting unit 6, which determines from them the lower instantaneous limiting value trqMin and upper instantaneous limiting value trqMax and supplies them to desired torque limiter 5. In addition, lower and upper instantaneous limiting values trqMin, trqMax are also supplied to torque requester 4, where they are used to initialize a filter, for example, which filters unlimited desired torque trqDesEng. Lower and upper instantaneous limiting values trqMin, trqMax are used to initialize the filter when desired torque trqDesEng, which is to be supplied, encounters one of the limits defined by lower and upper instantaneous limiting values trqMin, trqMax.

In addition, limiting unit 6 receives limited desired torque trqDesEngLtd from desired torque limiter 5. Torque requester 4 also supplies an intervention signal bCtOff, indicating a change from injection operation of all cylinders to the overrun fuel cutoff operation or indicating in general the change from a first torque range that is permissible in the steady state during normal operation, i.e., a usable first torque range, to another torque range that is permissible in the steady state during normal operation, i.e., a usable torque range.

In addition, torque requester 4 supplies an operating mode signal bNorm, with which it is possible to indicate whether the internal combustion engine is to be operated in a normal operation or in an exceptional operating mode. The exceptional operating mode stipulates that the restriction of the torque range that is not permissible in the steady state is to be eliminated, so that all torque ranges may be retrieved by torque requester 4, also for longer periods of time. Therefore, it may occur, for example, that internal combustion engine 2 is operated with injection blank-out of individual cylinders also for longer periods of time.

Moreover, it may be provided that the information about basic torque Eng_trqBs and/or minimal basic torque Eng_trqMinBsMin and/or minimal torque Eng_trqMin is also supplied to torque requester 4, for example, in hybrid vehicles having a degree of freedom in the choice of operating point, i.e., various desired torques may be supplied, depending on the operating point, in order to select optimal operating points for internal combustion engine 2 and/or one or more electric motors or hydraulic motors and thereby optimizing the driving strategy.

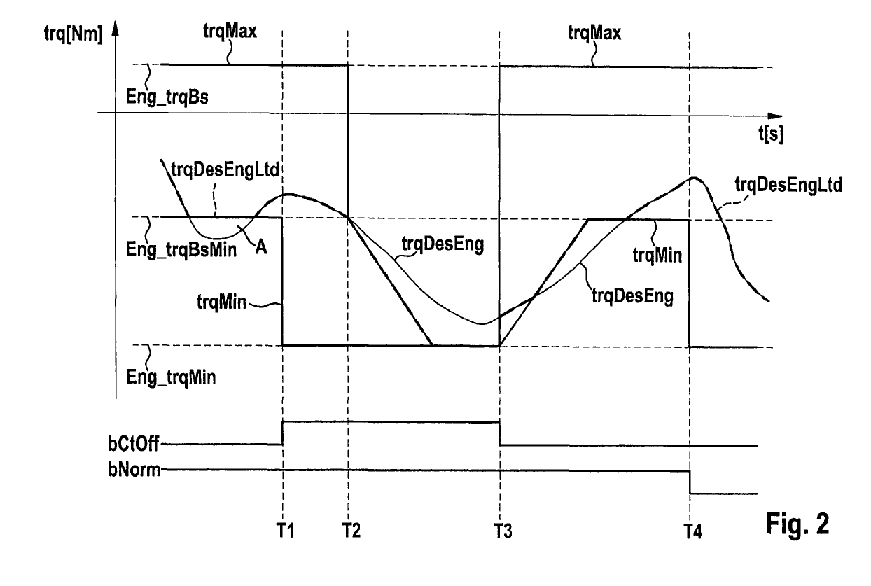

The functioning of limiting unit 6 becomes clear from the signal-time diagram in FIG. 2. Basic torque Eng_trqBs, minimal basic torque Eng_trqBsMin and minimal torque Eng_trqMin are represented as dashed horizontal lines in the signal-time diagram in FIG. 2. Basic torque Eng_trqBs and minimal basic torque Eng_trqBsMin depend on the operating point, so they depend in particular on the air filling of the cylinders and the instantaneously adjustable ignition angle values. Minimal torque Eng_trqMin depends primarily on the rpm of internal combustion engine 2. Between basic torque Eng_trqBs and minimal basic torque Eng_trqBsMin there is a first torque range that is permissible in the steady state. Minimal torque Eng_trqMin in this example determines the second torque range that is permissible in the steady state, which in this case corresponds only to a certain torque, namely the torque of internal combustion engine 2 during overrun fuel cutoff operation. A torque range that is not permissible in the steady state is defined between minimal basic torque Eng_trqBsMin and minimal torque Eng_trqMin.

Lower instantaneous limiting value trqMin and upper instantaneous limiting value trqMax, to which unlimited desired torque trqDesEng is limited, are represented by solid lines. A single solid line indicates the curve of desired torque trqDesEng. The curve of limited desired torque trqDesEngLtd is represented by the dashed line.

In addition, intervention signal bCtOff and operating mode signal bNorm are represented as a function of time, so that the corresponding changes in lower and upper instantaneous limiting values trqMin, trqMax are recognizable due to these signals. Since before a point in time T1, intervention signal bCtOff having a low level indicates that there is no request to change from injection operation of all cylinders to the overrun fuel cutoff, upper instantaneous limiting value trqMax corresponds to basic torque Eng_trqBs, and lower instantaneous limiting value trqMin corresponds to minimal basic torque Eng_trqBsMin. Desired torque trqDesEng runs briefly below lower instantaneous limiting value trqMin before point in time T1, so that desired torque limiter 5 is actively limiting and limited desired torque trqDesEngLtd deviates briefly from supplied desired torque trqDesEng, (see range A) and instead assumes the value of lower instantaneous limiting value trqMin. Therefore, a short-term injection blank-out, which would be carried out by engine control unit 3 at a desired torque trqDesEng below minimal basic torque Eng_trqBsMin, may be avoided.

At point in time T1, torque requester 4 specifies with a change in the level of intervention signal bCtOff a request to change to the overrun fuel cutoff, so that lower instantaneous limiting value trqMin jumps to minimal torque Eng_trqMin.

At point in time T2, limited desired torque trqDesEngLtd reaches minimal basic torque Eng_trqBsMin and thus unlimited desired torque trqDesEng or limited desired torque trqDesEngLtd enters a torque range that is not permissible in the steady state. As a result, upper instantaneous limiting value trqMax jumps to minimal basic torque Eng_trqBsMin (point in time T2) and its time curve proceeds like a ramp in the direction of minimal torque Eng_trqMin. The ramp shape of the time curve is defined and specified.

Desired torque trqDesEng runs above the ramp-shaped curve of upper instantaneous limiting value trqMax, so that desired torque trqDesEng is limited to the curve of upper instantaneous limiting value trqMax, i.e., limited desired torque trqDesEngLtd runs along upper instantaneous limiting value trqMax and then corresponds to minimal torque Eng_trqMin at trqMax=trqMin=Eng_trqMin as soon as the ramp-shaped curve of upper instantaneous limiting value trqMax has reached the lower instantaneous limiting value. Due to the defined ramp-shaped curve of upper instantaneous limiting value trqMax in the torque range that is not permissible in the steady state between minimal basic torque Eng_trqBsMin and minimal torque Eng_trqMin, this achieves the result that a limited desired torque trqDesEngLtd prevails only temporarily within the torque range that is not permissible in the steady state during normal operation.

If at point in time T1 a change to overrun fuel cutoff were to be blocked due to an additional restriction, for example, due to a too low temperature of a catalytic converter, which would result in an internal blockage of overrun fuel cutoff or an injection blank-out of the internal combustion engine, lower instantaneous limiting valve trqMin would still correspond to minimal basic torque Eng_trqBsMin and upper instantaneous limiting valve trqMax would still correspond to basic torque Eng_trqBs.

At point in time T3, torque requester 4 specifies a request to change to injection operation of all cylinders by changing intervention signal bCtOff to a low level. As a result, upper instantaneous limiting value trqMax jumps to basic torque Eng_trqBs, and lower instantaneous limiting value trqMin is guided in a ramp-shaped curve to minimal basic torque Eng_trqBsMin. At point in time T3, limited desired torque trqDesEngLtd then jumps to the value of desired torque trqDesEng and, if the value of desired torque trqDesEng falls below the ramp-shaped curve of lower instantaneous limiting value trqMin, then according to the ramp-shaped curve of lower instantaneous limiting value trqMin, it is guided to the value of minimal basic torque Eng_trqBsMin.

Alternatively, at point in time T3, lower instantaneous limiting value trqMin may initially jump to the value of unlimited desired torque trqDesEng and, beginning from there, be guided according to a ramp-shaped curve to minimal basic torque Eng_trqBsMin, so as not to shorten the dwell time in the range that is not permissible in the steady state. This achieves the result that there are no additional jumps in limited desired torque trqDesEngLtd.

Alternatively, the jump in limited desired torque trqDesEngLtd at point in time T3 is preventable if, starting at point in time T3, upper instantaneous limiting value trqMax proceeds to basic torque Eng_trqBs without any jumps, i.e., again in the form of a ramp. Limited desired torque trqDesEngLtd within the torque range that is not permissible in the steady state during normal operation also occurs only temporarily during the change to injection operation of all cylinders from the overrun fuel cutoff operation.

The ramp-shaped curves of lower and upper instantaneous limiting values trqMin, trqMax, whose slope is adaptable to the prevailing operating points such as rpm, temperature, and the like, from lower instantaneous limiting value trqMin or upper instantaneous limiting value trqMax during traversing the torque range that is not permissible in the steady state during normal operation are only examples. Other time curves or dependencies of additional parameters are also conceivable. For example, exponential curves or smoothed curves of the upper and lower instantaneous limiting values may also be provided.

A rapid change in lower instantaneous limiting value trqMin or upper instantaneous limiting value trqMax between minimal torque Eng_trqMin and minimal basic torque Eng_trqBsMin is optimal, for example, with respect to exhaust gas emissions but results in a rapidly changing limited desired torque trqDesEngLtd, which could have a negative effect on driving comfort. Rapid changes are the goal when compensation of the rapidly changing limited desired torque trqDesEngLtd by one or more electric motors or hydraulic motors is possible in hybrid drives. In hybrid vehicles, the curves of lower instantaneous limiting value trqMin and/or of upper instantaneous limiting value trqMax advantageously depend on the operating points of one or more of the electric motors or hydraulic motors or of a vehicle electrical system or a hydraulic power supply.

At point in time T4, torque requester 4 terminates normal operation by changing the level of operating mode signal bNorm to a low level, for example, because a safety-critical ESP intervention of a high priority exists. The instantaneous limiting values are then enabled at trqMin=Eng_trqMin and at trqMax=Eng_trqBs for the entire torque adjustment range of internal combustion engine 2. Limited desired torque trqDesEngLtd corresponds to desired torque trqDesEng, which is specified by a torque requester of a high priority (for example, an ESP block). Intervention signal bCtOff is of a lower priority than operating mode signal bNorm.

In the exemplary embodiment shown here, the torque ranges that are permissible in the steady state correspond to the torque range between basic torque Eng_trqBs and minimal basic torque Eng_trqBsMin as well as loss torque Eng_trqMin during overrun fuel cutoff operation of internal combustion engine 2. Alternatively or additionally, other torque ranges which are usable, i.e., permissible in a steady state, may also be defined; they are separated from one another by a torque range, in which steady-state use during normal operation is not permissible.

The duration of the ramp-shaped curve, i.e., the period of time during which upper instantaneous limiting value trqMax runs from minimal basic torque Eng_trqBsMin to minimal torque Eng_trqMin, may be between 100 ms and 500 ms, for example as a function of operating parameters of internal combustion engine 2. The ramp-shaped curve of lower instantaneous limiting value trqMin may have the same absolute value of the gradient of the ramp of the curve of upper instantaneous limiting value trqMax or may have an absolute value of the gradient which is different from that.

Instead of predefining upper and lower limiting values trqMin, trqMax, the specification variable, i.e., limited desired torque trqDesEngLtd, may be guided through the torque range that is not permissible in the steady state in accordance with a specified time curve. The time curve, which may correspond to a ramp function or some other monotonic function, for example, determines that limited (guided) desired torque trqDesEngLtd does not remain within the torque range that is not permissible in the steady state any longer than a specified maximum period of time. By providing the time curve with which limited (guided) desired torque trqDesEngLtd is guided, an abrupt transition between the torque ranges may be prevented on the one hand, while on the other hand, this also prevents remaining for too long in the torque range that is not permissible in the steady state, which is not desirable.

The specified maximum duration is selected in such a way that, on the one hand, it prevents the transition between the torque ranges that are permissible in the steady state which would impair driving comfort and, on the other hand, minimizes the period of time during which the torque range that is not permissible in the steady state prevails for the engine protection reasons described above. For example, the maximum period of time should also correspond at least to a period of time in which it is ensured that there is no acceleration and no change in torque during the transition between the torque ranges that are permissible in the steady state, whose absolute value is above a certain specified threshold value. This period of time could thus be defined by the size of the torque range that is not permissible in the steady state divided by the maximum desired change in torque. In traditional vehicles and engine systems, the specified maximum period of time is preferably between 0.1 seconds and 5 seconds, in particular between 0.5 seconds and 2 seconds.

1-18. (canceled)

19. A method for operating a drive unit including an internal combustion engine, comprising:
providing a specification variable for triggering the drive unit to supply an output variable;
providing a specification of operating point-dependent output variable ranges for the supplied specification variable, wherein in the operating point-dependent output variable ranges a steady-state operation of the drive unit is permissible, an output variable range that is not permissible in the steady state being defined between the operating point-dependent output variable ranges; and
triggering the drive unit on the basis of a guided specification variable when, in a transitional operating mode, a change in the specification variable for the drive unit necessitates traversing the output variable range that is not permissible in the steady state, wherein the guided specification variable is determined by guiding the specification variable, so that the period of time during which the drive unit is triggered for supplying the guided specification variable within the output variable range that is not permissible in the steady state is limited to a specified maximum period of time.

20. The method as recited in claim 19, wherein the specification variable is guided by limiting the specification variable with respect to at least one limiting value to obtain the guided specification variable, the at least one limiting value being obtained from at least one specified limiting value curve between a first range of the output variable ranges and a second range of the output variable ranges.

21. The method as recited in claim 20, wherein the specification variable is limited to one of the first range or the second range of the output variable ranges when there is no transitional operating mode.

22. The method as recited in claim 20, wherein the first range and the second range of the output variable ranges are each defined by a lower output variable range limit and an upper output variable range limit, the upper output variable range limit of the second range being smaller than the lower output variable range limit of the first range, the limiting value curve being defined as monotonic and steady between the upper output variable range limit of the second range and the lower output variable range limit of the first range within the specified maximum period of time.

23. The method as recited in claim 19, wherein the specification variable corresponds to a desired torque specification and the output variable ranges correspond to torque ranges.

24. The method as recited in claim 23, wherein at least one of:
(i) the first torque range is defined as the torque range between a minimal basic torque indicating the minimal drive torque suppliable by intervention in the ignition angle at the existing air filling in the cylinders of the engine and an optimal basic torque indicating the maximal drive torque suppliable by intervention in the ignition angle at the existing air filling in the cylinders; and
(ii) the second torque range represents a minimal torque which is determined by the torque supplied by the drive unit at the instantaneous operating point during an overrun fuel cutoff operation.

25. The method as recited in claim 23, wherein, when the transitional operating mode is present, and when there is a change in the operating point of the drive unit from the first torque range to the second torque range, then the desired torque specification is limited to an upper limiting value specified by a first limiting value curve if the desired torque specification is within the torque range that is not permissible in the steady state.

26. The method as recited in claim 23, wherein, when the transitional operating mode is present, and when there is a change in the operating point of the drive unit from the second torque range to the first torque range, then the desired torque specification is limited to a lower limiting value specified by a second limiting value curve if the desired torque specification is within the torque range that is not permissible in the steady state.

27. The method as recited in claim 23, wherein, when the transitional operating mode is present, and when there is a change in the operating point of the drive unit from the second torque range to the first torque range, then the desired torque specification is limited to an upper limiting value specified by a third limiting value curve if the desired torque specification is within the torque range that is not permissible in the steady state.

28. The method as recited in claim 23, wherein, when the transitional operating mode is present, and when there is a change in the operating point of the drive unit from the first torque range to the second torque range, then the desired torque specification is limited to a lower limiting value specified by a fourth limiting value curve if the desired torque specification is within the torque range that is not permissible in the steady state.

29. The method as recited in claim 23, wherein the desired torque specification is limited with regard to at least one limiting value as a function of an operating mode signal configured to indicate whether there is normal operation or exceptional operation.

30. The method as recited in claim 23, wherein the transitional operating mode is determined as a function of an intervention signal indicating the change in operating point of the drive unit which necessitates traversing the output variable range that is not permissible in the steady state.

31. The method as recited in claim 23, wherein the specification variable is guided in such a way that the specification variable has a specified time curve within the output variable range that is not permissible in the steady state.

32. The method as recited in claim 31, wherein the specified time curve is measured in such a way that the guided specification variable reaches the subsequent operating range that is permissible in the steady state when the specified maximum period of time has elapsed.

33. A device for operating a drive unit including an internal combustion engine, comprising:
a requester for supplying a specification variable for triggering the drive unit to supply an output variable;
a specification variable guidance unit for guiding the specification variable;
an engine control unit to operate the drive unit so that an output variable of the drive unit is supplied in accordance with the guided specification variable;
a guidance unit configured to:
supply a specification of operating point-dependent output variable ranges for the supplied specification variable, wherein in the operating point-dependent output variable ranges a steady-state operation of the drive unit is permissible, an output variable range that is not permissible in the steady state being defined between the operating point-dependent output variable ranges; and
trigger the drive unit on the basis of the guided specification variable when, in a transitional operating mode, a change in the specification variable for the drive unit necessitates traversing the output variable range that is not permissible in the steady state;
wherein the guided specification variable is determined by guiding the specification variable so that the period of time during which the drive unit is triggered for supplying the guided specification variable within the output variable range that is not permissible in the steady state is limited to a specified maximum period of time.

34. The device as recited in claim 33, wherein the requester corresponds to a torque requester, the guidance unit corresponds to a limiting unit, and the specification variable guidance unit corresponds to a desired torque limiter.

35. An engine system, comprising:
a device for operating a drive unit including an internal combustion engine, the device including:
a requester for supplying a specification variable for triggering the drive unit to supply an output variable;
a specification variable guidance unit for guiding the specification variable;
an engine control unit to operate the drive unit so that an output variable of the drive unit is supplied in accordance with the guided specification variable;
a guidance unit configured to:
supply a specification of operating point-dependent output variable ranges for the supplied specification variable, wherein in the operating point-dependent output variable ranges a steady-state operation of the drive unit is permissible, an output variable range that is not permissible in the steady state being defined between the operating point-dependent output variable ranges; and
trigger the drive unit on the basis of the guided specification variable when, in a transitional operating mode, a change in the specification variable for the drive unit necessitates traversing the output variable range that is not permissible in the steady state;
wherein the guided specification variable is determined by guiding the specification variable so that the period of time during which the drive unit is triggered for supplying the guided specification variable within the output variable range that is not permissible in the steady state is limited to a specified maximum period of time; and
an engine control unit configured to trigger the drive unit as a function of the guided specification variable.

36. A non-transitory computer-readable data storage medium storing a computer program having program codes which, when executed on a computer, performs a method for operating a drive unit including an internal combustion engine, the method comprising:
providing a specification variable for triggering the drive unit to supply an output variable;
providing a specification of operating point-dependent output variable ranges for the supplied specification variable, wherein in the operating point-dependent output variable ranges a steady-state operation of the drive unit is permissible, an output variable range that is not permissible in the steady state being defined between the operating point-dependent output variable ranges; and
triggering the drive unit on the basis of a guided specification variable when, in a transitional operating mode, a change in the specification variable for the drive unit necessitates traversing the output variable range that is not permissible in the steady state, wherein the guided specification variable is determined by guiding the specification variable, so that the period of time during which the drive unit is triggered for supplying the guided specification variable within the output variable range that is not permissible in the steady state is limited to a specified maximum period of time.
